(19) United States
(12) Patent Application Publication
(10) Pub. No.: US 2005/0132584 A1
(43) Pub. Date: Jun. 23, 2005

(54) Saw blade connector

(76) Inventors: Webster Robert Cornwell, Ronan, MT (US); Nathan Cantlon, Charlo, MT (US); Michael David Feist, Polson, MT (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(21) Appl. No.: 10/980,897

(22) Filed: Jul. 15, 2004

Related U.S. Application Data
(60) Provisional application No. 60/488,146, filed on Jul. 16, 2003.

(51) Int. Cl. B23D 49/06

(52) U.S. Cl. 30/517; 30/392

(57) ABSTRACT

A saw blade connector (20) for a hand tool is provided. The saw blade connector includes a shaft (34) having a first end (36) adapted to be releasably attached to a hand tool, and a lock mechanism (32). The lock mechanism is operatively coupled to the shaft for reciprocating movement between a locked position, where at least a portion of the lock mechanism engages a saw blade (22) when the saw blade is coupled to the saw blade connector, and an unlocked position.

### CROSS-REFERENCE TO RELATED APPLICATION

This application claims the benefit of Provisional Application No. 60/488,146, filed on Jul. 16, 2003, the disclosure of which is hereby expressly incorporated by reference.

### FIELD OF THE INVENTION

The present invention relates generally to saw blade connectors and, more particularly, to saw blade connectors that are releasably attachable to hand-held tools.

### BACKGROUND OF THE INVENTION

Reciprocating saws, either manually or electrically operated, are used to cut a variety of materials, including stainless steel, wood, pipe, and conduits. Over time, the blade of such a saw, as with most other types of saw blades, become worn due to use and, therefore, must be replaced. As a result, most existing reciprocating saws include a feature that permits the saw blade to be replaced when worn.

As noted above, reciprocating saws are either manually or electrically operated. In either case, when the saw blade is worn, it must be replaced. Currently, most manually operated hand-held reciprocating saws include a saw blade attachment apparatus having a pair of tines spaced to receive one end of the saw blade. The saw blade is fastened to the handle by a pin inserted transversely through the tines and through one end of the saw blade.

In the case of electrically operated or powered hand tool, some existing designs have a fast change saw blade connector that are rotatably actuated between locked and unlocked positions. The designs of existing fast change connectors on the market are all intended to deal with the rapid forward and back motion of the electric powered reciprocating saws. These saws operate at speeds in excess of 3,000 strokes per minute. This rapid speed and directional change causes large inertial force on the blade connector. The momentum of the locking collar could overcome the locking aspect of the connector if the saw blade connector included a linearly actuated locking mechanism. Moreover, none of the existing connectors are known to include a supplemental restraint.

Although such saw blade attachment apparatuses are effective at attaching a replaceable saw blade to a handle or machine, they are not without their problems.

First, most currently available saw blade attachment apparatuses require the user to loosen a screw in order to remove or exchange saw blades and then retighten the screw before use. This requires the user to carry other tools, such as a screwdriver or hex key, for saw blade replacement. Additionally, because of the screw attachment, replacing saw blades is somewhat of a time-consuming task. Finally, although the saw blade is pinned within the blade attachment apparatus, it may rotate about the pin during use due to a worn interface between the saw blade and the saw blade attachment apparatus. This results in a potentially unsafe operating condition.

Thus, there exists a need for a saw blade connector that provides rapid saw blade replacement and a more secure attachment of the saw blade to the hand tool.

### SUMMARY OF THE INVENTION

In accordance with one embodiment of the present invention, a saw blade connector for a hand tool is provided. The saw blade connector includes a shaft having a first end adapted to be releasably attached to a hand tool, and a lock mechanism. The lock mechanism is operatively coupled to the shaft for reciprocating movement between a locked position, where at least a portion of the lock mechanism engages a saw blade when the saw blade is coupled to the saw blade connector, and an unlocked position.

In accordance with an aspect of another embodiment of the present invention, the lock mechanism includes a bearing member cooperatively disposed within the shaft and positioned for selective interference engagement with the saw blade to lock the saw blade within the saw blade connector when the lock mechanism is displaced into the locked position. In accordance with further aspects of yet another embodiment, the lock mechanism is configured to cooperate with a collar mounted on the shaft for reciprocating movement between the locked and unlocked positions. The collar includes a detent positioned to reciprocate the bearing member into and out of interference engagement with the saw blade.

In accordance with other aspects of still yet another embodiment of the present invention, the saw blade connector includes an anchor coupled to the shaft and positioned to engage a portion of the saw blade when the saw blade is coupled to the saw blade connector. In accordance with yet other aspects of another embodiment, the anchor is a pin.

A saw blade connector formed in accordance with the embodiments of the present invention has several advantages over currently available attachment assemblies. The lock mechanism provides for an easy and quick attachment assembly, thereby facilitating rapid blade replacement. Also, the first end of the shaft allows for the saw blade connector to be rapidly attached to a plurality of well-known tools. Finally, the anchor provides a supplemental restraint device to securely fasten the saw blade within the saw blade connector.

Thus, a saw blade connector formed in accordance with embodiments of the present invention provides for quick interchangeability of replaceable saw blades, is adapted to be used with a plurality of existing tools, and provides an additional restraint anchor to securely fasten replaceable blades within the saw blade connector.

### BRIEF DESCRIPTION OF THE DRAWINGS

The foregoing aspects and many of the attendant advantages of this invention will become better understood by reference to the following detailed description, when taken in conjunction with the accompanying drawings, wherein:

FIG. 1 is a side planar view of a saw blade connector formed in accordance with one embodiment of the present invention;

FIG. 2 is a side planar view of the saw blade connector of FIG. 1, shown as it would be used with a saw blade;

FIG. 3 is an isometric, exploded view of the saw blade connector of FIG. 1, showing various components including a shaft and a lock mechanism;

FIG. 4 is a side planar view of the saw blade connector of FIG. 1, partially cut away to show the saw blade connector in an unlocked position;

FIG. 5 is a side planar view of the saw blade connector of FIG. 1, partially cut away to show the saw blade connector in a locked position; and

FIG. 6 is a side planar view of the combination saw blade and saw blade connector of FIG. 2, partially cut away to show locking engagement of the saw blade connector with a saw blade and an anchoring aspect of the embodiment.

### DETAILED DESCRIPTION OF THE PREFERRED EMBODIMENT

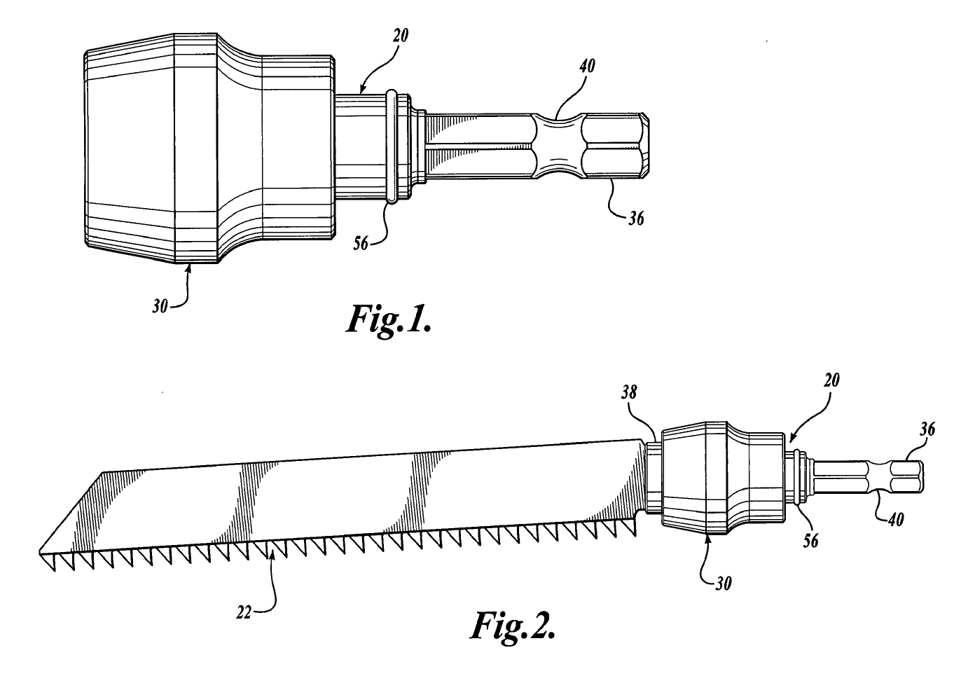

A saw blade connector 20 constructed in accordance with one embodiment of the present invention may be best understood by referring to FIGS. 1-3. The saw blade connector 20 is suitable for use with a well-known saw blade 22, such as a reciprocating saw blade. Such saw blades 22 are designed for replacement when the saw blade 22 is worn.

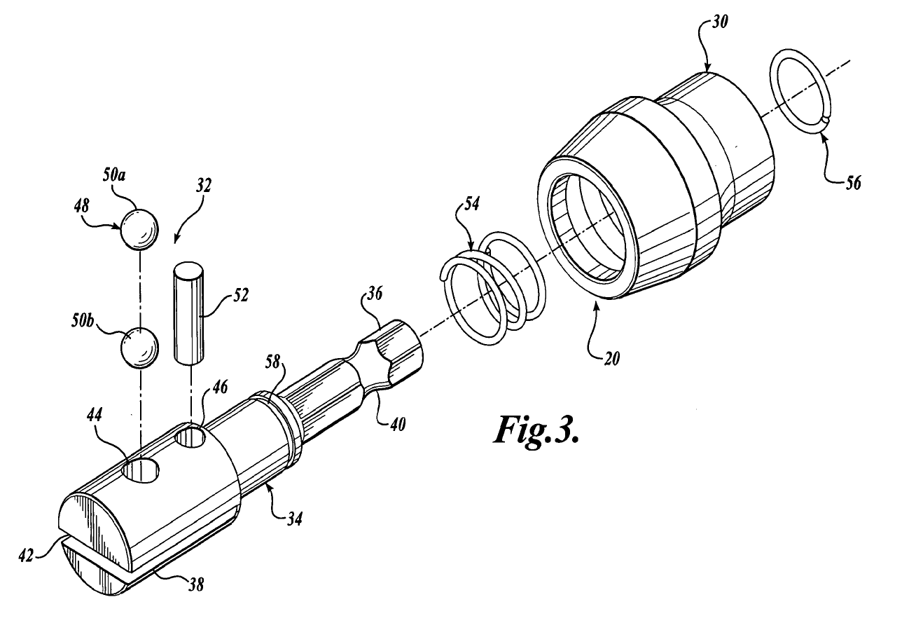

As may be best seen by referring to FIG. 3, the saw blade connector 20 includes a collar 30, a locking and anchoring assembly 32, and a shaft 34. The shaft 34 is suitably a cylindrical member formed from a high strength material and includes first and second ends 36 and 38.

The first end 36 is formed as a hex shank and is commonly used for quick connection to a handle of a hand tool or a chuck of an electrically operated machine, such as a reciprocating saw. The first end 36 includes a detent groove 40 sized and configured for locking engagement with a correspondingly shaped and configured locking mechanism (not shown), such as a ball bearing.

Although the shaft 34 is described and illustrated as including a hex shank first end 36 for replaceable attachment to a hand tool or a chuck, it should be apparent that the invention is not intended to be so limited. As a non-limiting example, the shaft 34 and, therefore, the resulting saw blade connector 20, may be pressed fit or integrally formed with a handle for permanent attachment with a hand tool. As a result, such embodiments are also within the scope of the present invention.

The second end 38 of the shaft 34 is suitably barrow-shaped and includes a slot 42 extending partially through a longitudinal direction of the shaft 34. The slot 42 is sized and configured to receive one end of the saw blade 22, as is described in greater detail below.

The second end 38 also includes a lock mechanism bore 44 and an anchor bore 46. Both the lock mechanism bore 44 and the anchor bore 46 extend substantially perpendicular to the longitudinal direction of the shaft 34. The lock mechanism bore 44 and anchor bore 46 are sized to receive components of the locking and anchoring assembly 32. In that regard, and as may be best seen by referring to FIG. 4, the lock mechanism bore 44 extends from an outside perimeter of the first end 38 through to the slot 42 and is sized to receive a lock mechanism 48 therein.

As may be best seen by referring back to FIG. 3, the lock mechanism 48 includes a bearing member, such as ball bearings 50a and 50b. Although the bearing member is illustrated and described as being a pair of ball bearings 50a and 50b, other types of bearing members, such as a single ball bearing or a pin, are also within the scope of the present invention. It has been discovered by the inventors of the present invention that two ball bearings 50a and 50b are preferred in the present embodiment. Two ball bearings 50a and 50b are preferred as the reduced diameter of two ball bearings, as opposed to a single ball bearing, allows for a shorter travel of the lock mechanism as it is reciprocated between the locked and unlocked positions.

The locking and anchoring assembly 32 also includes an anchor 52 sized to be received within the anchor bore 46. The anchor 52, as received within the anchor bore 46, is positioned to lockingly engage a portion of the saw blade 22 when the saw blade is inserted within the slot 42 of the shaft 34, as is described in greater detail below.

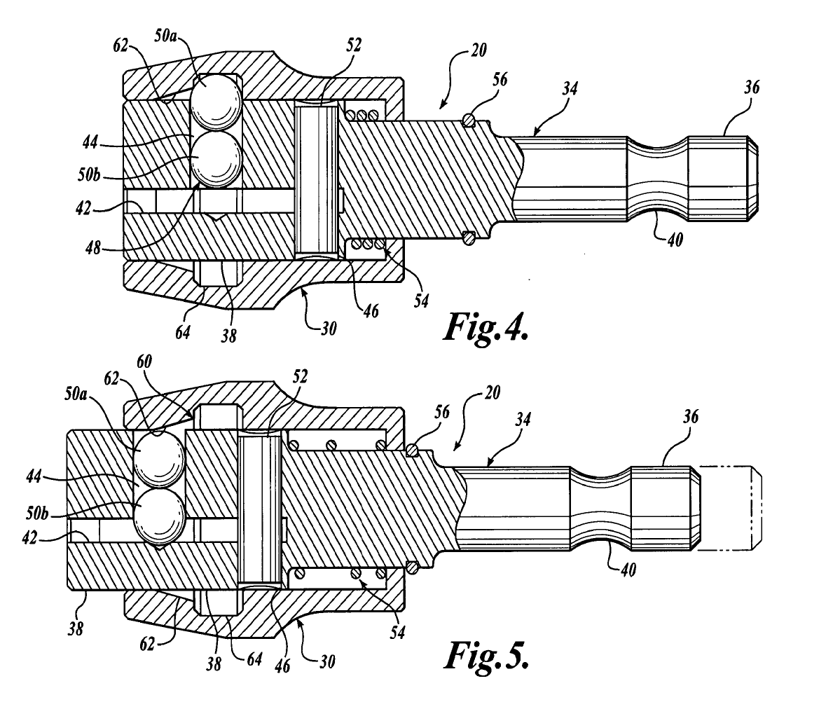

Still referring to FIG. 3, the collar 30 is mounted on the shaft 34 for reciprocating movement of the saw blade connector 20 between locked and unlocked positions. The collar 30 is suitably mounted to the shaft 34 on a biasing member 54, such as a coil compression spring. The biasing member 54 biases the collar 30 and, therefore, the saw blade connector 20 into the locked position, as seen in FIG. 5. The collar 30 is suitably locked to the shaft 34 by a well-known spring clip 56 sized to be lockingly received within a correspondingly shaped annular groove 58 formed in the shaft 34.

As may be best seen by referring to FIGS. 4 and 5, the collar 30 includes a detent 60 integrally formed within one end of the collar 30. The detent 60 is positioned to reciprocate the bearing member 48 into and out of interference engagement with the saw blade 22. The detent 60 includes a ramp 62 and a bearing cavity 64. The ramp 62 and bearing cavity 64 both extend around the inside perimeter of one end of the collar 30. The ramp 62 is adjacent the bearing cavity 64 and is positioned to assist reciprocating the bearing member 48 into and out of the locked and unlocked positions.

Operation of the saw blade connector 20 may be best understood by referring to FIGS. 4-6. When the saw blade connector 20 is displaced into the unlocked position of FIG. 4, the first and second ball bearings 50a and 50b are free to be displaced upwardly into the bearing cavity 64, such that an attachment end 70 of the saw blade 22 may be insertably received within the slot 42. The attachment end 70 of the saw blade 22 include a tang 72 extending therefrom. As the saw blade 22 is inserted in the slot 42, the tang 72 slides under the anchor 52 and the first and second ball bearings 50a and 50b are positioned adjacent a bore (not shown) extending through the attachment end 70 of the saw blade 22.

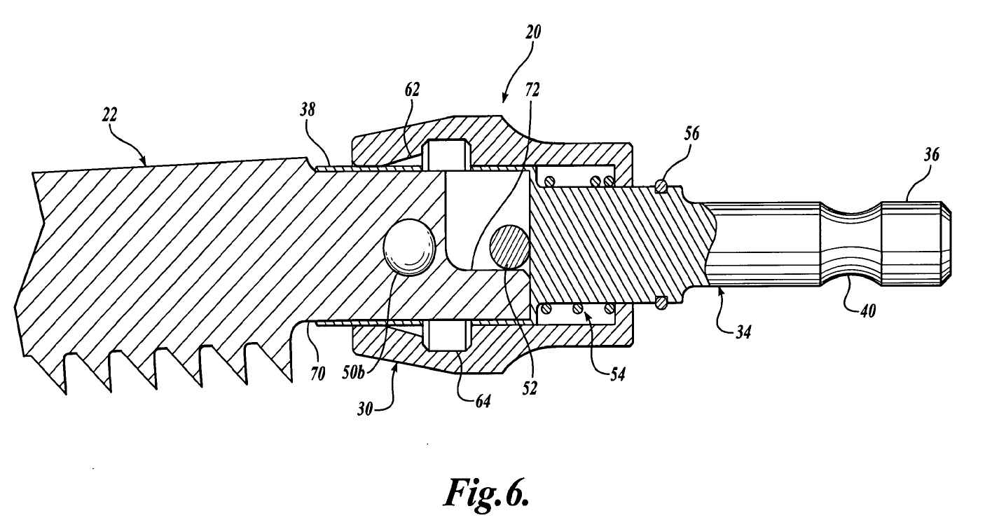

After the saw blade 22 is received within the slot 72, the collar 30 is displaced into the locked position, assisted by the biasing member 54. As seen in FIGS. 5 and 6, the collar 30 is displaced towards the first end 36 of the shaft 34 and into the locked position. As the collar 30 is displaced into the locked position, the ball bearings 50a and 50b are displaced within the lock mechanism bore 44 to at least partially seat the second ball bearing 50b within the bore extending through the attachment end 70 of the saw blade 22.

As received, the ball bearings 50a and 50b are placed into selective interference engagement with the saw blade 22 to lock the saw blade 22 within the saw blade connector 20. Additionally, the anchor 52 engages the tang 72 to further assist in restraining the saw blade 22 within the saw blade connector 20.

To remove the saw blade 22 from within the saw blade connector 20, the collar 30 is reciprocated into the unlocked position, thereby allowing the ball bearings 50a and 50b to retreat within the bearing cavity 64 and the saw blade 22 is then extracted from within the slot 42.

While the preferred embodiment of the invention has been illustrated and described, it will be appreciated that various changes can be made therein without departing from the spirit and scope of the invention.

1. In a manually operated hand tool of the type having a saw blade and a saw blade connector, the saw blade connector, comprising:
(a) a shaft having a first end adapted to be releasably attached to a hand tool; and
(b) a lock mechanism operatively coupled to the shaft for reciprocating movement between a locked position, where at least a portion of the lock mechanism engages a saw blade when the saw blade is coupled to the saw blade connector, and an unlocked position.

2. The saw blade connector of claim 1, wherein the lock mechanism comprises a bearing member cooperatively disposed within the shaft and positioned for selective engagement with the saw blade to lock the saw blade within the saw blade connector when the lock mechanism is displaced into the locked position.

3. The saw blade connector of claim 2, wherein the lock mechanism is configured to cooperate with a collar mounted on the shaft for reciprocating movement between the locked and unlocked positions, the collar having a detent positioned to reciprocate the bearing member into and out of engagement with the saw blade.

4. The saw blade connector of claim 3, further comprising an anchor coupled to the shaft and positioned to engage a portion of the saw blade when the saw blade is coupled to the saw blade connector.

5. The saw blade connector of claim 4, wherein the anchor is a pin.

6. The saw blade connector of claim 1, further comprising an anchor coupled to the shaft and positioned to engage a portion of the saw blade when the saw blade is coupled to the saw blade connector.

7. The saw blade connector of claim 2, further comprising an anchor coupled to the shaft and positioned to engage a portion of the saw blade when the saw blade is coupled to the saw blade connector.

8. In a manually operated hand tool of the type having a saw blade and a saw blade connector, the saw blade connector, comprising:
(a) a shaft having a first end adapted to be releasably coupled to a hand tool; and
(b) a locking and anchoring assembly coupled to the shaft for reciprocating movement between a locked position, where at least a portion of the locking and anchoring assembly lockingly interferes with a portion of a saw blade to the saw blade connector when the saw blade is coupled to the saw blade connector, and an unlocked position.

9. The saw blade connector of claim 8, wherein the shaft comprises a second end adapted to slidingly receive the saw blade.

10. The saw blade connector of claim 8, wherein the locking and anchoring assembly includes a bearing member disposed within the shaft for selective locking engagement with the saw blade when the saw blade is coupled to the saw blade connector.

11. The saw blade connector of claim 10, wherein the bearing member is a pin.

12. The saw blade connector of claim 10, wherein the bearing member is at least one ball bearing.

13. The saw blade connector of claim 12, wherein the locking and anchoring assembly is configured to cooperate with a collar slidably disposed on the shaft for reciprocating movement between the locked and unlocked positions, the collar including a detent positioned for reciprocating the at least one ball bearing into and out of locking engagement with the saw blade.

14. In a manually operated hand tool of the type having a saw blade and a saw blade connector, the saw blade connector, comprising:
(a) a shaft having a first end adapted to be releasably attached to a hand tool;
(b) a lock mechanism operatively coupled to the shaft for reciprocating movement between a locked position, where at least a portion of the lock mechanism engages a saw blade when the saw blade is coupled to the saw blade connector, and an unlocked position; and
(c) an anchor assembly disposed within the shaft, the anchor assembly positioned to anchor a saw blade within the shaft when the saw blade is coupled to the saw blade connector and the lock mechanism is displaced into the locked position.

15. In a manually operated hand tool of the type having a saw blade and a saw blade connector, the saw blade connector, comprising:
(a) a shaft having a first end adapted to releasably coupled to a hand tool;
(b) means for locking and anchoring a saw blade, the means for locking and anchoring a saw blade slidably coupled to the shaft for reciprocating movement between a locked position, where at least a portion of the means for locking and anchoring a saw blade is displaced into engagement with at least a portion of a saw blade when the saw blade is coupled to the saw blade connector, and an unlocked position.

16. In a manually operated hand tool of the type that includes a saw blade and a saw blade connector, the saw blade connector, comprising:
(a) a shaft; and
(b) a lock mechanism operatively coupled to the shaft for linear reciprocating movement between a locked position, where at least a portion of the lock mechanism engages a saw blade when the saw blade is coupled to the saw blade connector, and an unlocked position.

17. In a manually operated hand tool of the type having a saw blade and a saw blade connector, the saw blade connector, comprising:
(a) a shaft; and
(b) a locking and anchoring assembly coupled to the shaft for linear reciprocating movement between a locked position, where at least a portion of the locking and anchoring assembly lockingly interferes with a portion of a saw blade to the saw blade connector when the saw blade is coupled to the saw blade connector, and an unlocked position.
